(19) United States
(12) Patent Application Publication
(10) Pub. No.: US 2009/0265177 A1
(43) Pub. Date: Oct. 22, 2009

(54) SCHEDULED TELECOMMUNICATION SERVICE SUSPENSION

(75) Inventor: Michael L. SELBY, Carrollton, TX (US)

Correspondence Address: VERIZON;PATENT MANAGEMENT GROUP, 1320 North Court House Road, 9th Floor, ARLINGTON, VA, 22201-2909, US

(73) Assignee: GTE.Net LLC (d/b/a Verizon Internet Solutions), Grapevine, TX (US)

(21) Appl. No.: 12/103,829

(22) Filed: Apr. 16, 2008

(51) Int. Cl. G06Q 99/00

(52) U.S. Cl. 705/1

(57) ABSTRACT

A user may selectively schedule or otherwise control the temporary suspension of telecommunication services to which they subscribe. In one implementation, a request to temporarily suspend a telecommunication service may be received from the user. The user's telecommunication service may be temporarily suspended and then later restarted at times indicated by the request.

### BACKGROUND INFORMATION

In an increasingly digitally connected world, telecommunication services play a crucial role in the daily operation of businesses and consumers. Telecommunication services commonly used by both businesses and consumers include telephone, network (e.g., Internet) connectivity, and television. These services are typically provided to the customer premises by the telecommunication provider through one or more wired or wireless connections.

In normal operation, telecommunication services are commonly provided to the customer as an always active connection. That is, whenever the customer tries to use the service (e.g., turning on the television, using the Internet, etc.), it is available.

### BRIEF DESCRIPTION OF THE DRAWINGS

FIG. 1 is a diagram of an exemplary system in which concepts described herein may be implemented;

FIG. 2 is diagram illustrating exemplary components of a device shown in FIG. 1;

FIG. 3 is a diagram illustrating the system shown in FIG. 1, in which aspects relating to the server devices of FIG. 1 are shown in additional detail;

FIG. 4 is a flow chart of an exemplary process for scheduling telecommunication services at a customer premises;

FIG. 5 is a diagram illustrating an exemplary graphical interface for scheduling service suspensions;

FIG. 6 is a flow chart of an exemplary process for suspending and restarting telecommunication services at customer premises; and

FIG. 7 is a diagram illustrating an exemplary graphical interface for scheduling service suspensions based on a maximum time limit or bandwidth limit.

### DETAILED DESCRIPTION OF PREFERRED EMBODIMENTS

The following detailed description of exemplary embodiments refers to the accompanying drawings. The same reference numbers in different drawings may identify the same or similar elements. Also, the following detailed description does not limit the invention.

Implementations described herein allow customers to selectively schedule or otherwise control the temporary suspension of telecommunication services to which they subscribe. The customer may, for instance, for a certain period every day, schedule the temporary suspension of their television, Internet, or voice services.

Being able to selectively control when certain telecommunication services are available can be desirable in many situations. For instance, a parent may wish to limit the time that the family spends watching television or using the Internet.

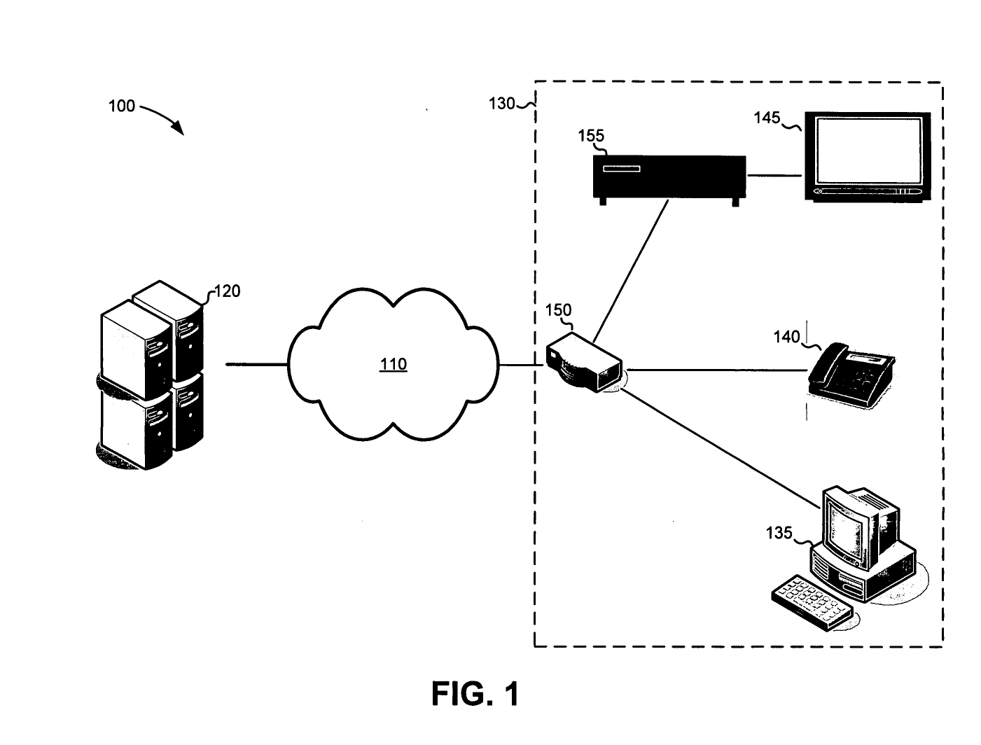

FIG. 1 is a diagram of an exemplary system 100 in which concepts described herein may be implemented. As illustrated, system 100 may include a first network 110 that connects one or more server devices 120 to a customer premises 130. In general, server devices 120 may provide or provide control over, via network 110, telecommunication services such as telephone, television, and/or network connectivity (e.g., Internet) to customer premises 130.

Network 110 may include a Local Area Network (LAN), a wide area network (WAN), such as a cellular network, a satellite network, or the Internet, a private WAN, or a combination of the Internet and a private WAN, that is used to transport data. Although shown as a single element in FIG. 1, network 110 may include a number of separate networks that function to provide services to customer premises 130. In one implementation, network 110 may terminate at customer premises 130 via an optical communication link, such as an optical fiber to the customer premises. In another possible implementation, network 110 may terminate at customer premises 130 via a coaxial cable.

Server devices 120 may include servers or other network devices used to deliver or control delivery of the telecommunication services to customer premises 130. For example, server devices 120 may include web servers, network switches or routers, television broadcast facilities. etc. In one implementation, server devices 120 may include one or more servers through which a user at customer premises 130 may interact and control the scheduling of telecommunication services to customer premises 130.

Customer premises 130 may include a number of electronic devices, such as computing device 135, telephone 140, and television 145. Customer premises 130 may additionally include devices that provide an interface to personal computer 135, telephone 140, and television 145, such as a local gateway 150 and a set-top box 155.

Computing device 135 may include, for example, a personal computer, such as desktop, laptop computer, personal digital assistant (PDA), etc., used for general computing tasks. In some implementations, computing device 135 may be a server computer designed to be accessed by many end-users.

Telephone 140 may include standard analog phones or VoIP (voice over IP) phones. As a VoIP phone, telephone 140 may be stand-alone telephone capable of initiating VoIP calls over network 110 or a “soft-phone” that is implemented as software on computing device 135.

Television 145 may include a digital or analog television through which a user may watch programming.

Gateway 150 may include a network device that provides an interface from network 110 to personal computer 135, telephone 140, and television 145. For example, when telecommunication services are provided to customer premises 130 via optical fiber, gateway 150 may include an optical network terminal (ONT) to connect to the optical fiber. The ONT may convert between signals appropriate for devices 135/140/145 and signals appropriate for transmission over optical fiber. For example, the ONT may include an Ethernet output port that connects to personal computer 135 or a VoIP telephone 140, a standard telephone port for connecting to a standard telephone 140, and a coaxial cable signal that leads to television 145 or set-top box 155.

Set-top box 155 may include a device for selecting and/or obtaining content that may be shown or played on television 145. Set-top box 155 may receive commands, such as commands transmitted via a remote control, and control television 145 accordingly. Set-top box 155 may also be capable of sending data to server devices 120. For example, users may use a remote control or wireless keyboard to interact with set-top box 155 and television 145 in an interactive session.

In general, customer premises 130 may be either a residential or business location. Additionally, although only a single personal computer 135, telephone 140, and television 145 are shown in FIG. 1, it can be appreciated that any particular customer premises 130 may have any number (including none) of any of these devices. Further, although a single customer premises 130 is shown in FIG. 1, servers devices 120 may typically interact with many customer premises.

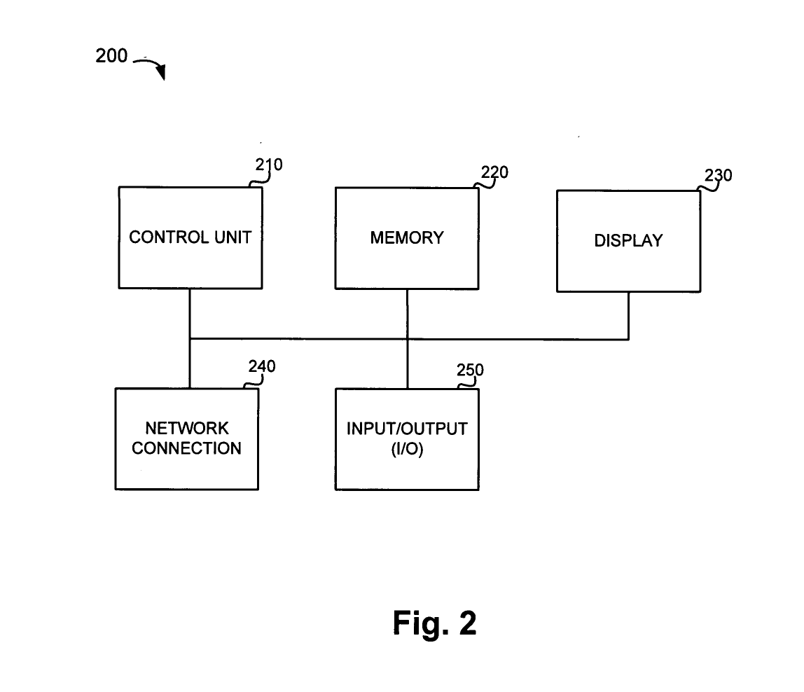

FIG. 2 is diagram illustrating exemplary components of one of the devices shown in FIG. 1, such as a server in server devices 120, computing device 135, telephone 140, television 145, gateway 150, or set-top box 155. For convenience, the exemplary components of any of these devices will be referred to as device 200 in the discussion of FIG. 2. Device 200 may include control unit 210, memory 220, display 330, network connection 240, and input/output (I/O) component 250.

Control unit 210 may include a processor, microprocessor, or other type of processing logic that may interpret and execute instructions. Memory 220 may include a dynamic or static storage device that may store information and instructions for execution by control unit 210. For example, memory 220 may include a storing component, such as a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory.

Display 230 may include any component capable of providing visual information. For example, in one implementation, display 230 may be a liquid crystal display (LCD). In another implementation, display 230 may be any one of other display technologies, such as a plasma display panel (PDP), a field emission display (FED), a thin film transistor (TFT) display, etc. Display 230 may display, for example, text, image, and/or video information. Display 230 may be an optional component. In some implementations of device 200, such as when device 200 represents server devices 120 or gateway 150, a display may not be used.

Network connection 240 may include any transceiver-like mechanism that enables device 200 to communicate with other devices and/or systems. For example, network connection 240 may include an Ethernet interface, an optical interface, a coaxial interface, a radio interface, or the like. Network connection 240 may allow for wired, wireless, and/or optical communication. Network connection 240 may be particularly configured to connect device 200 to a packet-based IP network.

Input/output devices 250 may generally include user input devices such as external buttons, a keyboard or mouse and output devices such as a display or printer. With input/output devices 250, a user may generally interact with device 200. In some implementations, device 200 may be a “headless” device, in which case input/output devices 250 may be absent. When device 200 is set-top box 155, input/output device 250 may particularly be implemented as a remote control.

As will be described in detail below, device 200 may perform certain operations relating to communications over a network. Device 200 may perform these operations in response to control unit 210 executing software instructions contained in a computer-readable medium, such as memory 220. A computer-readable medium may be defined as a physical or logical memory device.

The software instructions may be read into memory 220 from another computer-readable medium or from another device. The software instructions contained in memory 220 may cause control unit 210 to perform processes that will be described later. Alternatively, hardwired circuitry may be used in place of or in combination with software instructions to implement processes described herein. Thus, implementations described herein are not limited to any specific combination of hardware circuitry and software.

Although FIG. 2 illustrates exemplary components of device 200, in other implementations, device 200 may include fewer, additional, and/or different components than those depicted in FIG. 2. In still other implementations, one or more components of device 200 may perform one or more other tasks described as being performed by one or more other components of device 200.

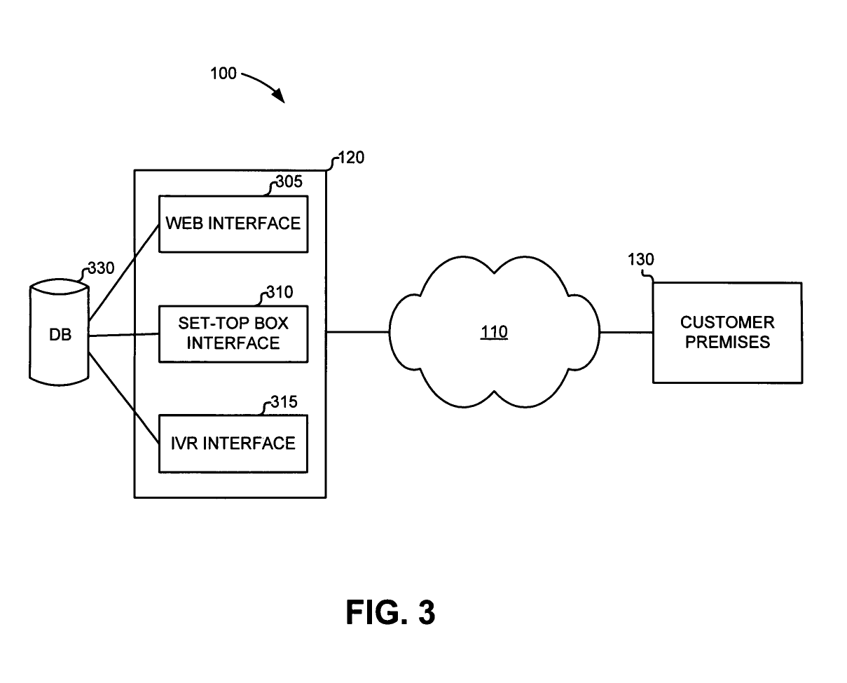

FIG. 3 is a diagram illustrating system 100, in which aspects relating to server devices 120 are shown in additional detail. As shown, server devices 120 may include web interface component 305, set-top box interface component 310, and interactive voice response (IVR) interface component 315. Components 305, 310, and 315 may communicate with database 330 to store information relating to customer service schedules. More particularly, web interface component 305, set-top box interface component 310, and IVR interface component 315 may each be configured to interact with users to allow users to schedule suspension of their telecommunication services.

Web interface component 305 may include one or more computing devices (e.g., web servers) through which users of computing devices 135 may interact. Users of computing devices 135 may, for example, through web browsing software, communicate with web interface component 305 to schedule suspensions of their telecommunication services.

Set-top box interface component 310 may include one or more devices that communicate with set-top boxes 155. Set-top boxes 155 may communicate with set-top box interface component 310 when sending or receiving dynamic or unique user requested data. For example, a user watching television 145 through set-top box 155 may view their local weather forecast by sending a request through set-top box 155, which may forward the request to set-top box interface component 310. In response, set-top box interface component 310 may transmit the weather forecast back to set-top box 155, which may then display the forecast on television 145. Consistent with some implementations described herein, users of set-top box 155 may use a graphical interface presented by set-top box and television 145 to schedule suspensions of their telecommunication services. In some implementations, instead of communicating with a separate set-top box interface component, set-top box 155 may communicate with web interface component 305. In this situation, set-top box 155 may include an embedded web browser.

IVR interface component 315 may provide a voice interface though which users can schedule suspension of their telecommunication services. For example, a user of telephone 140 may call IVR interface component 315 (such as by dialing a pre-designated number) and then, through either voice commands or commands entered via a keypad of telephone 140, may schedule suspension of their telecommunication services.

In general, server devices 120 provide one or more different interfaces through which users may interact. Although three different interfaces are illustrated in FIG. 3 (web interface component 305, set-top box interface component 310, and IVR interface component 315), it can be appreciated that some of these interfaces may be absent or, in some implementations, an additional interface may be present.

Database 330 may include one or more devices configured to store information relating to suspension of the user telecommunications services. Server devices 120 may update database 330 based on interaction with users. For example, for each scheduled service suspension, server devices 120 may store the scheduled beginning time and ending time of the service suspension, as well as the particular type of service that is to be suspended (e.g., Internet connectivity, television service, or phone service).

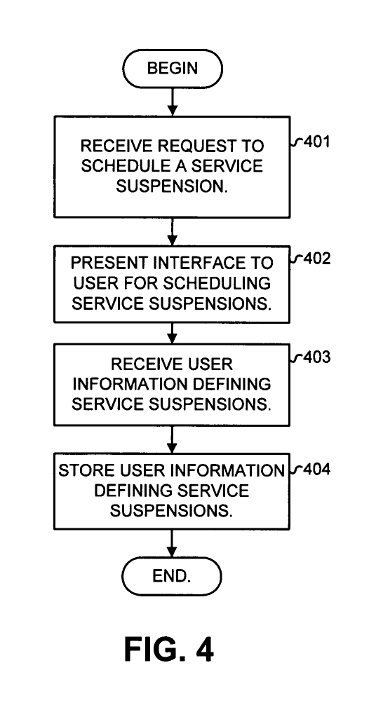

FIG. 4 is a flow chart of an exemplary process for scheduling telecommunication services at customer premises 130.

A user may initially send a request to server devices 120 to schedule a service suspension (block 401). The request may be performed via a number of possible methods, such as via a browser based web interface (e.g., a user of computing device 135 interacting with web interface component 305), an interface presented through television 145 (e.g., set-top box 155 communicating with set-top box interface 310), or by a voice interface that the user interacts with using telephone 140. The user may choose the method of interacting with server devices 120 that is most convenient for the user.

Server devices 120 may initially authenticate the user attempting to schedule a service suspension. For example, when the user is visually interacting with service devices 120, such as via a web connection, the user may authenticate the session by entering a password. For an audio connection, voice recognition techniques, a spoken password, or caller ID information may be used. In some situations, such as when interacting through a set-top box, the set-top box may already be authenticated and no additional authentication may be necessary.

Server devices 120 may present an interface to the user designed to allow the user to schedule service suspensions (block 402). The interface may be, for example, a graphical menu or, in the case when the user is interacting through a voice interface, an audible menu.

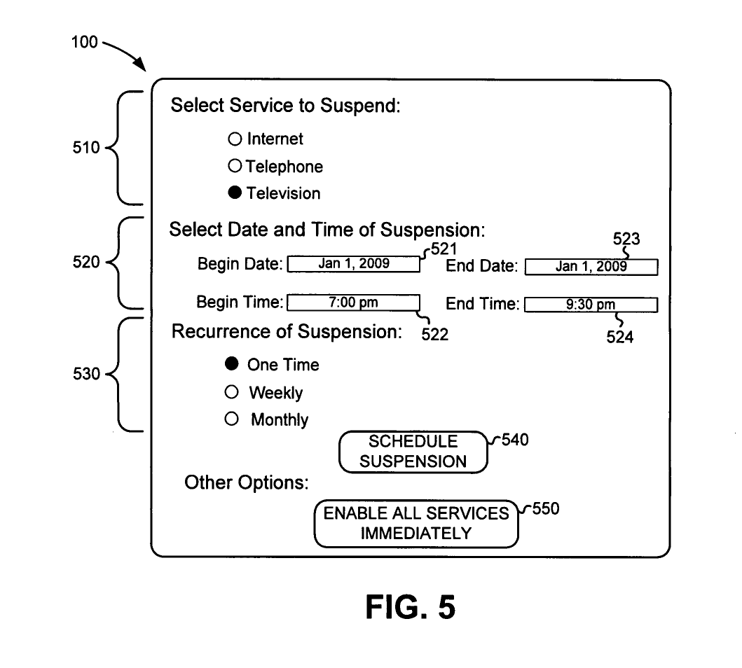

FIG. 5 is a diagram illustrating an exemplary graphical interface 500 for scheduling service suspensions. Graphical interface 500 may be presented, for example, by web interface component 305 via a web browser executing at computing device 135.

As shown, graphical interface 500 includes a section 510 for selecting the service that is to be suspended, a section 520 for selecting the when the service is to suspended, a section 530 for selecting the recurrence interval of the suspension, a button 540 for submitting the scheduled suspension to server device 120, and an “enable all services” button 550. In section 510, the user may select the service or services they would like to suspend. In this example, three possible services are shown: Internet, telephone, and television. The user has selected the button corresponding to television service.

In section 520, the user may select the date and time range for the service suspension. Four input boxes, 521-524, are shown as being used to store the date and time to begin and end the service suspension. In this example, the user has selected the begin date and time as Jan. 1, 2009 (box 521) at 7:00 pm (box 522) and the end date and time as Jan. 1, 2009 (box 523) at 9:30 pm (box 524).

A user scheduling a service suspension may wish to schedule the suspension at the same time every day, week, or month, etc. In section 530 of menu 500, the user may select whether the service suspension is to be a recurring event. In this example, three options are given: “one time only,” “weekly,” or “monthly.” As shown, the user has selected “one time only,” indicating that the scheduled service suspension is not to be a recurring event.

Command button 540 may be allow the user to submit the scheduled service suspension. User selection of this button may cause the information entered into graphical interface 500 to be sent to server devices 120 or directly to database 330.

Other options may be presented via graphical interface 500. For example, it may be desirable to provide users with a convenient method to, regardless of the status of previously submitted scheduled service suspensions, enable all services that are currently suspended. In this example, command button 550, when selected, may send such a command to server devices 120.

It can be appreciated that the interface for scheduling service suspensions shown in FIG. 5 (i.e., graphical interface 500) is only one example of a possible interface. Other visual interfaces, with different styles or options, may be used in any particular implementation. Further, in situations in which the interface is an audio interface, options such as those shown in FIG. 5 may be presented as audio options. In still another possible implementation, an interface may be presented as a combination of both visual and audio information.

Referring back to FIG. 4, server device 120 may receive the information defining the scheduled service suspensions, such as the information submitted through graphical interface 500 (block 403). Server devices 120 may store the information defining the scheduled service suspensions, such as by storing the information in database 330 (block 404).

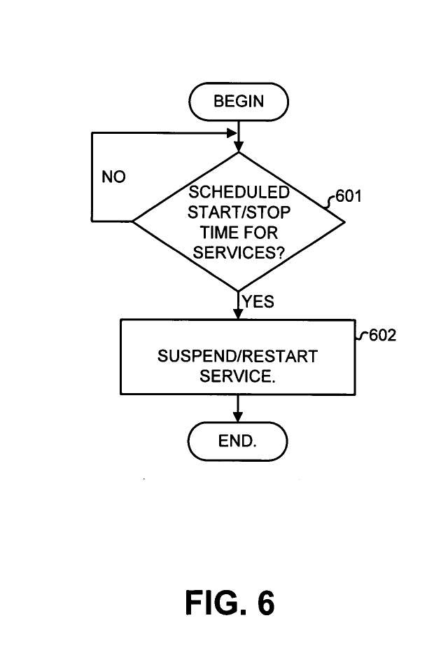

FIG. 6 is a flow chart of an exemplary process for suspending and restarting telecommunication services at customer premises 130. Based on the information in database 330, services may be suspended and restarted as appropriate for customer premises 130.

Database 330 may be monitored to determine whether a scheduled service suspension start time or service suspension end time is reached (block 601). This monitoring may be performed by, for example, server devices 120. When it is time for a service for a particular customer premises to be suspended or restarted, server devices 120 may cut-off or restart the service at the customer premises (block 602). For example, server devices 120 may signal the appropriate network infrastructure in network 110 to cut-off or restart the service at the customer premises. In implementations in which the service is provided directly by server devices 120, server devices 120 may directly cut-off or restart the service at the customer premises.

In one particular implementation, server devices 120, when cutting-off or restarting service at customer premises 130, may do so by signaling local gateway 150 or set-top box 155. Local gateway 150, for example, may then block (or stop blocking) the specified services. For television service, set-top box 155 may alternatively perform the suspension (blocking) and restarting of television services.

In yet another possible alternative implementation, local gateway 150 and/or set-top box 155 may implement some or all of the functionality described previously for server devices 120. A user at customer premises 130 may thus schedule service suspension directly with local gateway 150 or set-top box 155. For example, local gateway 150 may run a web server program that allows users to connect to and set service suspension options using an interface similar to that shown in FIG. 5. Local gateway 150 may then block or unblock the telecommunication services pursuant to the schedules directly programmed into these devices.

In some implementations, instead of scheduling the suspension of services for a particular time period, customer's may be given the option of suspending services based on one or more additional factors. One such additional factor may include a maximum time limit for a service over a particular interval. For example, a user may choose that no more than three hours of television should be watched in a day. Another such factor may include a maximum bandwidth limit for a service over a particular interval. For example, a user may specify that no more than 2 gigabytes of data are downloaded each week.

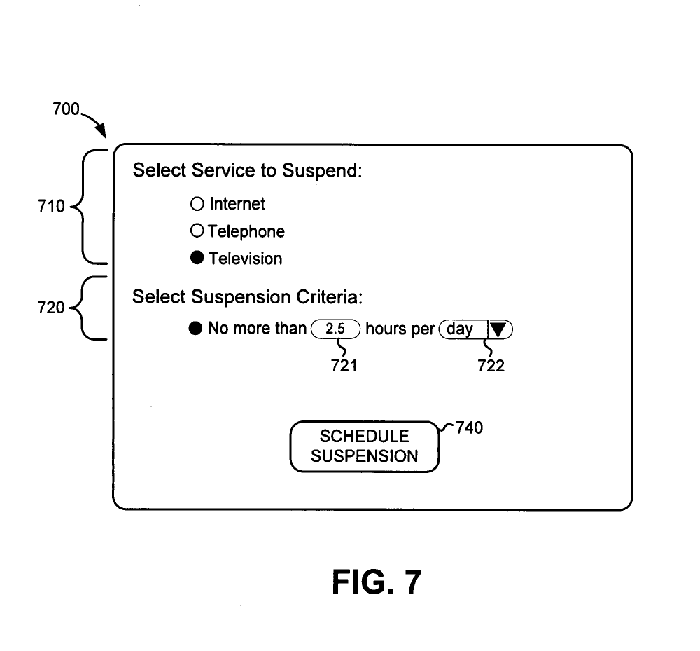

FIG. 7 is a diagram illustrating an exemplary graphical interface 700 for scheduling service suspensions based on a maximum time limit or bandwidth limit. Graphical interface 700 may be presented, for example, by web interface component 305 via a web browser executing at computing device 135.

As with graphical interface 500, graphical interface 700 includes a section, labeled in FIG. 7 as section 710, for selecting the service that is to be suspended. In this example, the user has selected television service.

In section 720, the user may select the criteria desired for suspending the selected service. In one implementation, the available options shown in this section may change based on the criteria available for the selected service. For example, telephone and television services may allow the user to select a criteria based on a maximum time limit while the criteria for Internet may be based on a maximum bandwidth. In this example, the user has selected television. Accordingly, section 720 may provide the user options relating to a maximum time limit for television service. In particular, text entry box 721 and drop down box 722 may allow the user to enter a maximum number of hours per period that the user would like television to be available. As shown in FIG. 7, the user has indicated that television service should be available for no more than 2.5 hours each day.

Command button 740 may be provided to allow the user to submit the scheduled service suspension. User selection of this button may cause the information entered in sections 710 and 720 to be sent to server devices 120.

In some implementations, the ability to suspend a service may be limited to certain portions of the service. For example, for telephone service, emergency dialing (e.g., 911 calls) may always remain active. Further, in some implementations, a service may only be partially suspended. For example, a user may elect to suspend outgoing telephone calls but still allow incoming telephone calls. As another example, a user may elect to suspend pay-per-view television service but still allow regular television service.

Allowing customers to selectively suspend service for telecommunications services, as described above, can provide a useful and beneficial service to the customer. A customer can, for example, elect to suspend certain services during mealtimes, at night, or on days they feel these services are unnecessary or unwanted.

The foregoing description of implementations provides illustration, but is not intended to be exhaustive or to limit the implementations to the precise form disclosed. Modifications and variations are possible in light of the above teachings or may be acquired from practice of the teachings.

In addition, while a series of blocks and/or acts have been described with regard to processes illustrated in FIGS. 4 and 6, the order of the acts and/or messages may be modified in other implementations. Further, non-dependent acts may be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a”, “an”, and “the” are intended to include one or more items. Where only one item is intended, the term “one” or similar language is used. Further, the phrase “based on” is intended to mean “based, at least in part, on” unless explicitly stated otherwise.

What is claimed:

1. A method comprising:
receiving a request, from a customer associated with a telecommunication service, to temporarily suspend the telecommunication service;
suspending the telecommunication service at a time indicated in the request; and
restarting the telecommunication service based on the request.

2. The method of claim 1, where the request includes an explicit indication of when the telecommunication service is to be suspended and an explicit indication of when the telecommunication service is to be restarted.

3. The method of claim 1, where the request includes an indication that the temporary suspension of the telecommunication service is to be a recurring event.

4. The method of claim 1, where the request includes an indication of which of a plurality of possible telecommunication services are to be suspended.

5. The method of claim 4, where the plurality of possible telecommunication services include television service, network connectivity, or telephone service.

6. The method of claim 1, where the request is received via an interface presented to the customer as a graphical web-based interface, an interface presented via a set-top box, or as an audible interface presented by a interactive voice response (IVR) system.

7. The method of claim 1, where the request indicates that the telecommunication service is to be suspended after a maximum amount of usage is exceeded in a given time period.

8. The method of claim 7, where the maximum amount of usage is specified as a maximum number of hours per day or as a maximum bandwidth usage per day.

9. The method of claim 1, further comprising:
receiving a second request from the customer to restart the suspended telecommunication service; and
restarting the telecommunication service in response to the second request.

10. A system comprising:
one or more processors; and
computer readable media coupled to the one or more processors, the computer readable media storing programming instructions for execution by the one or more processors, the programming instructions including
instructions for providing an interface to a user to facilitate receiving a request from the user to temporarily suspend a telecommunication service provided to the user, the request including information describing when the telecommunication service is to be suspended,
controlling suspension of the telecommunication service based on the request, and
restarting the suspended telecommunication service based on the request.

11. The system of claim 10, where controlling suspension of the telecommunication service and restarting the suspended telecommunication service are performed by one or more server devices located remotely from a premises of the customer.

12. The system of claim 10, where controlling suspension of the telecommunication service and restarting the suspended telecommunication service is performed by a local gateway located on a premises of the customer.

13. The system of claim 12, where the local gateway includes an optical network terminal (ONT).

14. The system of claim 10, where the request includes an indication of which of a plurality of possible telecommunication services are to be suspended.

15. The system of claim 10, where the request is received via an interface presented to the user as a graphical web-based interface, an interface presented via a set-top box, or as an audible interface.

16. The system of claim 10, where the request indicates that the telecommunication service is to be suspended after a maximum amount of usage is exceeded in a given time period.

17. The system of claim 16, where the maximum amount of usage is specified as a maximum number of hours per day or as a maximum bandwidth usage per day.

18. A device comprising:
means for receiving a request, from a customer associated with a telecommunication service, to temporarily suspend the telecommunication service;
means for suspending the telecommunication service at a time indicated in the request; and
means for restarting the telecommunication service at a time determined from the request.

19. The device of claim 18, where the request includes a time describing when the telecommunication service is to be suspended and a time describing when the telecommunication service is to be restarted.

20. The device of claim 18, where the request indicates that the telecommunication service is to be suspended after a maximum amount of usage is exceeded in a given time period.

21. A method comprising:
receiving a request form a user, via an automated interface, to suspend a telecommunication service of the user, the request including a specified time that the telecommunication service is to be suspended and a period of the suspension for the telecommunication service;
suspending a telecommunication service at the specified time; and
restarting the telecommunication service after the period has elapsed.

22. The method of claim 21, where the telecommunication service includes television service, network connectivity, or telephone service.

23. The method of claim 21, where the request includes an indication that the suspension of the telecommunication service is to be a recurring event.
